(19) United States
(12) Patent Application Publication
(10) Pub. No.: US 2026/0361895 A1
(43) Pub. Date: Nov. 12, 2026

(54) VIDEO UPLOADING METHOD AND APPARATUS, AND DEVICE AND STORAGE MEDIUM

(71) Applicants: LEMON INC., GRAND CAYMAN (KY); BEIJING ZITIAO NETWORK TECHNOLOGY CO., LTD., BEIJING (CN)

(72) Inventors: Liyang SUN, Los Angeles, CA (US); Mingming SHEN, Beijing (CN); Lei ZHAI, Beijing (CN); Qian MA, Beijing (CN)

(21) Appl. No.: 19/129,642

(22) PCT Filed: Mar. 13, 2024
(86) PCT No.: PCT/CN2024/081497

§ 371 Date: May 13, 2025

(30) Foreign Application Priority Data
Mar. 31, 2023 (CN) 202310341772.0

(51) Int. Cl. H04N 19/166; H04N 19/119; H04N 19/174; H04N 21/2743

(52) U.S. Cl. CPC H04N 19/166; H04N 19/119; H04N 19/174; H04N 21/2743

(57) ABSTRACT

Embodiments of the present disclosure provide a video uploading method, apparatus, device and storage medium. The method comprises: obtaining current video data to be uploaded; determining a target first slice data amount matching a current upload network based on historical upload network information; and slicing the current video data based on the target first slice data amount to obtain a current video slice to be uploaded currently, and uploading the current video slice.

### CROSS-REFERENCE TO RELATED APPLICATION(S)

The present disclosure claims priority to Chinese Application No. 202310341772.0 filed on Mar. 31, 2023, and entitled “VIDEO UPLOADING METHOD AND APPARATUS, AND DEVICE AND STORAGE MEDIUM”, the disclosure of which is incorporated herein by reference in its entity.

### FIELD

The present disclosure relates to the Internet technology, and in particular, to a video uploading method, apparatus, device and storage medium.

### BACKGROUND

With the rapid development of computer technology, video data may be updated through a network. For example, a video captured by a user may be uploaded to a server. At present, common practice is to upload entire video data at a time. However, in the event of a packet upload error due to an excessive amount of video data, the entire video data needs to be re-uploaded, resulting in a serious waste of data and a lower upload success rate.

### SUMMARY

The present disclosure provides a video uploading method, apparatus, device and storage medium, wherein video data is uploaded in the form of a slice to avoid retransmission of entire video data, and a video slice data amount uploaded each time may be dynamically adjusted during the video uploading process, so that the upload success rate is increased.

In a first aspect, an embodiment of the present disclosure provides a video uploading method, comprising:
obtaining current video data to be uploaded;
determining a target first slice data amount matching a current upload network based on historical upload network information; and
slicing the current video data based on the target first slice data amount to obtain a current video slice to be uploaded currently, and uploading the current video slice.

In a second aspect, an embodiment of the present disclosure further provides a video uploading apparatus, comprising:
a current video data obtaining module configured to obtain current video data to be uploaded;
a target first slice data amount determining module configured to determine a target first slice data amount matching a current upload network based on historical upload network information; and
a current video slice uploading module configured to slice the current video data based on the target first slice data amount to obtain a current video slice to be uploaded currently, and upload the current video slice.

In a third aspect, an embodiment of the present disclosure provides an electronic device, comprising:
one or more processors;
a storage unit configured to store one or more programs,
wherein the one or more programs, when executed by the one or more processors, cause the one or more processors to implement a video uploading method of any of the embodiments of the present disclosure.

In a fourth aspect, an embodiment of the present disclosure provides a storage medium comprising computer executable instructions, wherein the computer executable instructions, when executed by a computer processor, are used for performing a video uploading method of any of the embodiments of the present disclosure.

According to the technical solution of the embodiments of the present disclosure, a target first slice data amount matching a current upload network is determined based on historical upload network information; the current video data is sliced based on the target first slice data amount to obtain a current video slice to be uploaded currently, and the current video slice is uploaded. In this way, video data is uploaded in the form of a slice, and each slice may be independently uploaded and checked, so that only slices which fail to be transmitted may be re-transmitted and the entire video data avoids retransmission. Moreover, during the video uploading process, the slice data amount uploaded each time may be dynamically adjusted, so that the video slice data amount matches an upload network each time and further the upload success rate of the video slice may be increased.

### BRIEF DESCRIPTION OF THE DRAWINGS

Through the following detailed implementations with reference to the accompanying drawings, the above and other features, advantages and aspects of respective embodiments of the present disclosure will become more apparent. The same or similar reference numerals represent the same or similar elements throughout the figures. It should be understood that the figures are merely schematic, and components and elements are not necessarily drawn to scale.

FIG. 1 illustrates a schematic flowchart of a video uploading method according to an embodiment of the present disclosure;

FIG. 2 illustrates a schematic diagram of another video uploading method according to an embodiment of the present disclosure;

FIG. 3 illustrates a schematic flowchart of a further video uploading method according to an embodiment of the present disclosure;

FIG. 4 illustrates a structural schematic diagram of a video uploading apparatus according to an embodiment of the present disclosure; and

FIG. 5 illustrates a structural schematic diagram of an electronic device according to an embodiment of the present disclosure.

### DETAILED DESCRIPTION OF EMBODIMENTS

The embodiments of the present disclosure will be described in more detail with reference to the accompanying drawings, in which some embodiments of the present disclosure have been illustrated. However, it should be understood that the present disclosure can be implemented in various manners, and thus should not be construed to be limited to embodiments disclosed herein. On the contrary, those embodiments are provided for the thorough and complete understanding of the present disclosure. It should be understood that the drawings and embodiments of the present disclosure are only used for illustration, rather than limiting the protection scope of the present disclosure.

It should be understood that various steps described in method implementations of the present disclosure may be performed in a different order and/or in parallel. In addition, the method implementations may comprise an additional step and/or omit a step which is shown. The scope of the present disclosure is not limited in this regard.

The term “comprise/include” and their variants used herein are to be read as open terms that mean “include, but is not limited to.” The term “based on” is to be read as “based at least in part on.” The term “one embodiment” are to be read as “at least one embodiment.” The term “another embodiment” is to be read as “at least one other embodiment.” The term “some embodiments” are to be read as “at least some embodiments.” Other definitions will be presented in the description below.

Note that the concepts “first,” “second” and so on mentioned in the present disclosure are only for differentiating different apparatuses, modules or units rather than limiting the order or mutual dependency of functions performed by these apparatuses, modules or units.

Note that the modifications “one” and “a plurality” mentioned in the present disclosure are illustrative rather than limiting, and those skilled in the art should understand that unless otherwise specified, they should be understood as “one or more.”

Names of messages or information interacted between a plurality of apparatuses in the implementations of the present disclosure are merely for the illustration purpose, rather than limiting the scope of these messages or information.

It is to be understood that, before applying the technical solutions disclosed in various embodiments of the present disclosure, the user should be informed of the type, scope of use, and use scenario of the personal information involved in the present disclosure in an appropriate manner in accordance with relevant laws and regulations, and user authorization should be obtained.

Meanwhile, it is to be understood that data involved in the present technical solution (including but not limited to the data itself, the acquisition or use of the data) should comply with requirements of corresponding laws and regulations and relevant rules.

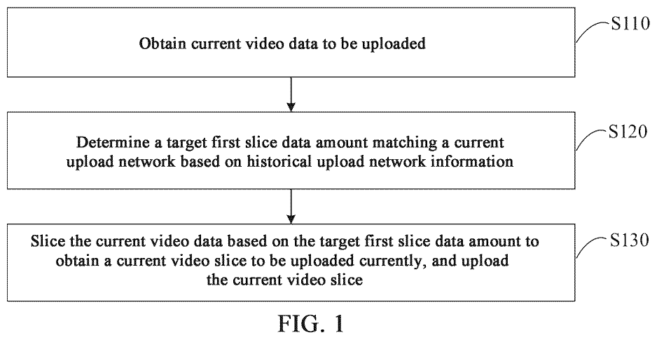

FIG. 1 is a schematic flowchart of a video uploading method according to an embodiment of the present disclosure. The embodiment of the present disclosure is applicable to a situation in which video data is uploaded in the form of a slice. The method may be performed by a video uploading apparatus, and the apparatus may be implemented in the form of software and/or hardware, and optionally, implemented through an electronic device. The electronic device may be a mobile terminal, a PC, a server, etc.

As shown in FIG. 1, the video uploading method specifically comprises the following steps:

S110, obtaining current video data to be uploaded.

The current video data may be video data to be uploaded currently. The current video data may be all or part of data in a video to be uploaded. For example, in a scenario where the video is encoded-synthesized and then uploaded, the entire video data resulting from the video encoding synthesis may be used as the current video data to be uploaded. For another example, in a synthesis-while-uploading scenario, the currently synthesized part of the video data may be obtained from the encoder as the current video data to be uploaded each time.

S120, determining a target first slice data amount matching a current upload network based on historical upload network information.

The historical upload network information may refer to network information when the video slice is uploaded prior to a current point of time. For example, the historical upload network information may comprise at least one of a historical upload network speed and a historical retransmission count. The current upload network may refer to a network of a current uploaded video slice. The current upload network is a further network that uploads a video slice after a current point of time. The target first slice data amount may refer to a slice data amount required for the current uploaded video slice. The target first slice data amount may be used for characterizing the size of the current uploaded video slice. For example, the target first slice data amount may be 512 KB. The target first slice data amount matching the current upload network may mean that the current upload network is capable of successfully uploading a video slice having the target first slice data amount. It is to be noted that different upload networks may correspond to different first slice data amounts, so that the size of a video slice uploaded each time may be dynamically adjusted during video uploading and the video uploading success rate may be guaranteed.

Specifically, current upload network information may be predicted based on historical upload network information, and a target first slice data amount corresponding to the current upload network information may be determined based on a mapping relationship between upload network information and a first slice data amount. Or the target first slice data amount matching the current upload network may be fast and accurately obtained based on the historical upload network information by means of machine learning. By determining the target first slice data amount matching the current upload network, the video slice size may be increased as much as possible under the premise of ensuring the upload success rate, and in turn the quantity of slices and the overall video transmission time consumption may be reduced.

As an example, S120 may comprise: inputting historical upload network information to a pretrained neural network model for prediction of a first slice data amount; and obtaining a target first slice data amount matching a current upload network based on an output of the neural network model.

The neural network model may be a machine learning model for predicting a first slice data amount. The network architecture of the neural network model may be any regression network model. The neural network model in this embodiment may be preobtained based on sample data so as to guarantee the prediction accuracy of the first slice data amount.

Specifically, historical upload network information may be input to a pretrained neural network model. The neural network model may predict, based on the input historical upload network information, a target first slice data amount required for the current video slice to be uploaded, and output the target first slice data amount. Thus, with the neural network model, the target first slice data amount matching the current upload network may be fast and accurately obtained, and the video uploading success rate may be further guaranteed.

S130, slicing the current video data based on the target first slice data amount to obtain a current video slice to be uploaded currently, and uploading the current video slice.

The slice size of the current video slice is the target first slice data amount. Specifically, video data in size of the target first slice data amount in the current video data may be used as the current video slice to be uploaded, and the current video slice is uploaded to the server by using the current upload network, thus completing a process of uploading the video slice. If the data amount of the current video data is greater than the target first slice data amount, the remaining video data after the current upload will be uploaded next time, thereby realizing the video uploading in a slice form. The uploading process of each video slice in the same video may be implemented through steps S110-S130.

According to the technical solution of the embodiments of the present disclosure, a target first slice data amount matching a current upload network is determined based on historical upload network information; the current video data to be uploaded is sliced based on the target first slice data amount to obtain a current video slice having the target first slice data amount, and the current video slice is uploaded. In this way, video data is uploaded in the form of slices, and each slice may be independently uploaded and checked, so that only slices which fail to be transmitted may be re-transmitted and the entire video data avoids retransmission. Moreover, during the video uploading process, the slice data amount uploaded each time may be dynamically adjusted, so that the video slice data amount matches an upload network each time and further the upload success rate of the video slice may be increased.

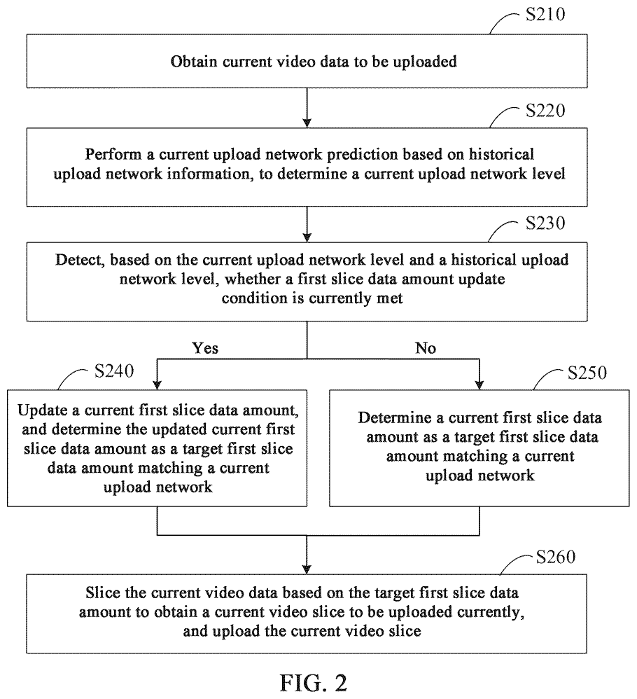

FIG. 2 is a schematic flowchart of another video uploading method according to an embodiment of the present disclosure. Based on the foregoing embodiments of the present disclosure, this embodiment further optimizes the step of “determining a target first slice data amount matching a current upload network based on historical upload network information”, wherein explanations of terms which are the same as or corresponding to those in the foregoing respective embodiments are not repeated herein.

As shown in FIG. 2, the video uploading method specifically comprises the following steps:
S210, obtaining current video data to be uploaded;
S220, performing a current upload network prediction based on historical upload network information, to determine a current upload network level.

The upload network level may be pre-obtained by grading upload network performance based on historical data. There may be a variety of upload network levels. For example, there may be three upload network levels, namely a high network level, a medium network level and a low network level, depending on the level of upload network performance. The current upload network level may refer to an upload network level corresponding to a network uploading the video slice currently.

Specifically, the prediction and classification of the current upload network level may be performed by machine learning. For example, the historical upload network information may be input to a pretrained level classification model for prediction of the current upload network level, and the current upload network level may be obtained based on an output of the level classification model. Or the current upload network level may be determined as a low upload network level in the event of failure for a preset count of consecutive uploads.

As an example, S220 may comprise: predicting a current upload network speed based on at least one of a historical upload network speed, a historical upload failure rate and a historical retransmission count; and determining a current upload network level based on a correspondence relationship between the current upload network speed, an upload network speed interval and an upload network level.

The upload network speed interval may refer to a range of upload network speed variation. Each upload network level corresponds to an upload network speed interval. A grading critical value between two adjacent upload network speed intervals may be obtained through offline data analysis. For example, an upload network speed interval less than or equal to p50 corresponds to a low network level; an upload network speed interval greater than p50 and less than or equal to p75 corresponds to a medium network level; and an upload network speed interval greater than p75 corresponds to a high network level.

Specifically, a current upload network speed may be predicted based on at least one of a historical upload network speed, a historical upload failure rate and a historical retransmission count through machine learning or network speed regression, and a predicted current upload network speed may be obtained. The current upload network speed is compared with each upload network speed interval to determine a target upload network speed interval to which the current upload network speed belongs, and an upload network level corresponding to the target upload network speed interval is determined as a current upload network level.

S230, detecting, based on the current upload network level and a historical upload network level, whether a first slice data amount update condition is currently met; if yes, performing step S240, otherwise performing step S250.

The historical upload network level may refer to an upload network level corresponding to an uploaded video slice. The historical upload network level may comprise an upload network level each time a video slice is uploaded prior to the current point of time. For example, if a current upload is the 3^{rd} upload, then the historical upload network level may comprise: 1^{st} upload network level and 2^{nd} upload network level. The first slice data amount update condition may refer to a condition to be met for updating the currently set first slice data amount, i.e., a condition to be met for updating the first slice data amount of the last uploaded video slice.

Specifically, the current upload network level may be compared with the latest upload network level; if the current upload network level is not equal to the latest upload network level, it may be determined that the first slice data amount update condition is currently met; otherwise, it may be determined that the first slice data amount update condition is not met currently.

As an example, the first slice data amount update condition may comprise a first slice data amount increase condition and a first slice data amount decrease condition, wherein the first slice data amount increase condition may refer to a condition to be met for increasing the currently set first slice data amount, and the first slice data amount decrease condition may refer to a condition to be met for decreasing the set currently first slice data amount.

For example, S230 may comprise: determining that a first slice data amount increase condition is currently met in response to determining, based on a current upload network level and a historical upload network level, that a count that two adjacent upload network levels have continuously increased is greater than a preset count; and determining a first slice data amount decrease condition is currently met in response to determining, based on a current upload level and a historical upload network level, that a count that two adjacent upload network levels have continuously decreased is greater than a preset count.

Specifically, if the preset count is 2 times and a current upload is the 4^{th} upload, where the 4^{th} upload network level is higher than the 3^{rd} upload network level and the 3^{rd} upload network level is higher than the 2^{nd} upload network level, it is determined that the first slice data amount increase condition is currently met. Where the 4^{th} upload network level is lower than the 3^{rd} upload network level and the 3^{rd} upload network level is lower than the 2^{nd} upload network level, it is determined that the first slice data amount decrease condition is currently met. When a count that upload network levels have continuously increased or decreased is greater than a preset count, it indicates stable variation in the upload network, at which point the currently set first slice data amount is allowed to increase or decrease so as to ensure that the adjusted first slice data amount may be successfully uploaded.

S240, updating a current first slice data amount, and determining the updated current first slice data amount as a target first slice data amount matching a current upload network, and performing step S260.

The current first slice data amount may refer to a currently set first slice data amount, i.e., the data amount of the last uploaded video slice. At the first upload, the current first slice data amount may be set to an initial value.

Specifically, when the first slice data amount update condition is currently met, the current first slice data amount may be increased or decreased, and the increased or decreased current first slice data amount may be determined as a target first slice data amount matching a current upload network.

As an example, S240 may comprise: in response to determining that a first slice data amount increase condition is currently met, increasing a current first slice data amount, and determining the increased current first slice data amount as a target first slice data amount matching a current upload network.

Specifically, when the first slice data amount increase condition is currently met, the current first slice data amount may be increased based on a preset increase mode, and the increased current first slice data amount may be determined as the target first slice data amount.

As an example, increasing the current first slice data amount may comprise: using a next first slice data amount which is adjacent to a current first slice data amount as an increased current first slice data amount based on an order of a first slice data amount sequence; or using a first slice data amount corresponding to a current upload network level as an increased current first slice data amount based on a correspondence relationship between an upload network level and a first slice data amount.

Specifically, a first slice data amount sequence in which first slice data amounts are increased sequentially may be preset based on business requirements. The current first slice data amount may be gradually increased in the order of the first slice data amount sequence. Or the first slice data amount which may be successfully uploaded under each upload network level may be predetermined based on historical slice upload data, and a correspondence relationship between an upload network level and a first slice data amount may be built. The higher the upload network level, the better the upload network performance, and accordingly, the larger the first slice data amount. Based on the correspondence relationship, a first slice data amount corresponding to a current upload network level may be used as an increased current first slice data amount, so that the current first slice data amount may be increased based on the current upload network level. It is to be noted that where the current upload network level meets the first slice data amount increase condition, this means that the current upload network level is higher than a historical upload network level, so that the first slice data amount corresponding to the current upload network level is larger than the current first slice data amount.

As an example, S240 may further comprise: in response to determining that a first slice data amount decrease condition is currently met, decreasing a current first slice data amount, and determining the decreased current first slice data amount as a target first slice data amount matching a current upload network.

Specifically, when the first slice data amount decrease condition is currently met, the current first slice data amount may be decreased based on a preset decrease mode, and the decreased current first slice data amount may be determined as a target first slice data amount.

As an example, decreasing the current first slice data amount may comprise: using a next first slice data amount which is adjacent to a current first slice data amount as a decreased current first slice data amount based on an order of a first slice data amount sequence; or using a first slice data amount corresponding to a current upload network level as a decreased current first slice data amount based on a correspondence relationship between an upload network level and a first slice data amount.

Specifically, a first slice data amount sequence in which first slice data amounts are increased sequentially may be preset based on business requirements. The current first slice data amount may be gradually decreased in the order of the first slice data amount sequence. Or the first slice data amount which may be successfully uploaded under each upload network level may be predetermined based on historical slice upload data, and a correspondence relationship between an upload network level and a first slice data amount may be built. The lower the upload network level, the worse the upload network performance, and accordingly, the less the first slice data amount. Based on the correspondence relationship, a first slice data amount corresponding to a current upload network level may be used as a decreased current first slice data amount, so that the current first slice data amount may be decreased based on the current upload network level. It is to be noted that where the current upload network level meets the first slice data amount decrease condition, this means that the current upload network level is lower than a historical upload network level, so that the first slice data amount corresponding to the current upload network level is less than the current first slice data amount.

S250, determining the current first slice data amount as a target first slice data amount matching a current upload network, and performing step S260.

Specifically, where a first slice data amount update condition is not met currently, the current first slice data amount does not need to be updated, at which point the current first slice data amount may be directly determined as the target first slice data amount.

S260, slicing the current video data based on the target first slice data amount to obtain a current video slice to be uploaded currently, and uploading the current video slice.

According to the technical solution of the embodiments of the present disclosure, a current upload network prediction is performed based on historical upload network information, to determine a current upload network level; it is detected, based on the current upload network level and a historical upload network level, whether a first slice data amount update condition is currently met; a current first slice data amount is updated in response to determining that the first slice data amount update condition is currently met, and the updated current first slice data amount is determined as a target first slice data amount matching a current upload network. In this way, the video slice data amount uploaded each time may be dynamically adjusted so as to be adapted to each upload network, and further the video uploading success rate may be guaranteed.

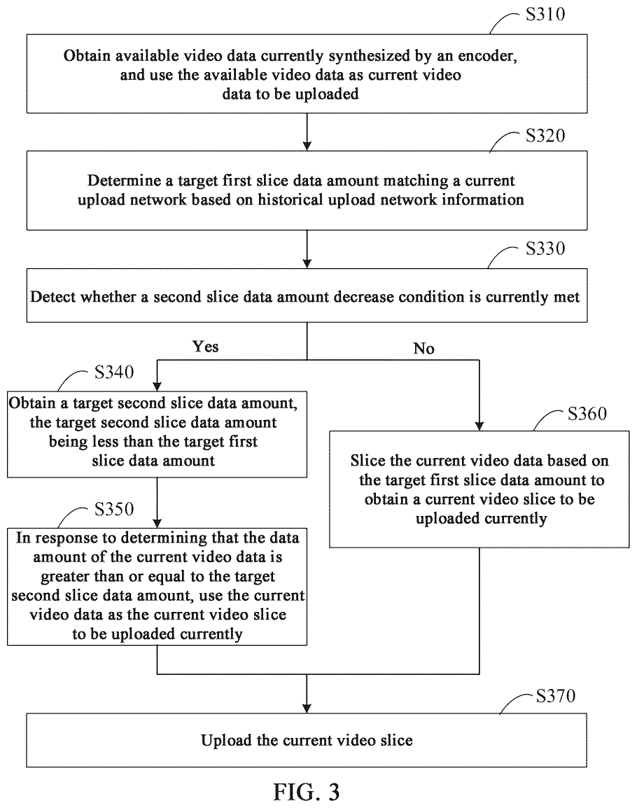

FIG. 3 is a schematic flowchart of a further video uploading method according to an embodiment of the present disclosure. Based on the foregoing embodiments of the present disclosure, this embodiment optimizes the step of “obtaining current video data to be uploaded”, and on this basis, further optimizes the step of “slicing the current video data based on the target first slice data amount to obtain a current video slice to be uploaded currently”. Explanations of terms which are the same as or corresponding to those in the foregoing respective embodiments are not repeated herein.

As shown in FIG. 3, the video uploading method specifically comprises the following steps:

S310, obtaining available video data currently synthesized by an encoder, and using the available video data as current video data to be uploaded.

The encoder is used for encoding-synthesizing a video to be uploaded. The available video data may refer to video data which is currently synthesized by the encoder and is to be uploaded.

Specifically, in a synthesis-while-uploading scenario, currently synthesized available video data may be obtained from an encoder as current video data to be uploaded, during each uploading. In the synthesis-while-uploading scenario, the upload frequency of video slices is limited by the synthesis speed of the encoder. For example, at a lower synthesis speed, it is necessary to wait for the encoder to synthesize a certain amount of video data before uploading.

S320, determining a target first slice data amount matching a current upload network based on historical upload network information;

S330, detecting whether the data amount of current video data is less than a target first slice data amount or not; if yes, performing step S340; otherwise performing step S360.

Specifically, by detecting whether the data amount of current video data is less than the target first slice data amount, it is determined whether a video slice having the target first slice data amount may be uploaded currently.

S340, obtaining a target second slice data amount, the target second slice data amount being less than the target first slice data amount.

Specifically, where the data amount of current video data is less than the target first slice data amount, it indicates that the available video data amount currently synthesized by the encoder is not enough to upload a video slice having the target first slice data amount, at which point a target second slice data amount may be obtained. The target second slice data amount may be used for characterizing the minimum slice data amount which is allowed to be uploaded currently. The target first slice data amount may be used for characterizing the maximum slice data amount which is allowed to be uploaded currently. The target second slice data amount may be set to a fixed value, i.e., the target second slice data amount which is allowed to be uploaded each time remains the same. The target second slice data amount may also be set to a dynamically-varying value, so as to reduce the waiting time and thus the transmission time of the entire video.

As an example, S340 may comprise: detecting whether a second slice data amount decrease condition is currently met, based on a data synthesis speed and/or a historical upload wait count; in response to determining that the second slice data amount decrease condition is currently met, decreasing a current second slice data amount, and using the decreased current second slice data amount as the target second slice data amount; and in response to determining that the second slice data amount decrease condition is not met currently, using a current second slice data amount as the target second slice data amount.

The data synthesis speed may refer to a speed at which the encoder encodes compressed data. The historical upload wait count may refer to a wait count that it is necessary to wait for the encoder to synthesize data for each historical upload. That is, the data amount of available video data obtained each time historically is less than the target second slice data amount. The current second slice data amount may refer to the minimum slice data amount currently set which is allowed to be uploaded, i.e., the minimum slice data amount which is allowed to be uploaded during last uploading. The second slice data amount decrease condition may refer to a condition to be met for decreasing the current second slice data amount.

Specifically, where the data synthesis speed is less than a preset speed and/or the historical upload wait count is larger than a preset count, it indicates that the current second slice data amount is set too large and needs to be decreased. At this point, it may be determined that the second slice data amount decrease condition is currently met; otherwise, it may be determined that the second slice data amount decrease condition is not met currently. Where the second slice data amount decrease condition is currently met, a preset data amount may be subtracted from the current second slice data amount, and the obtained subtraction result is used as the target second slice data amount. Where the second slice data amount decrease condition is not met currently, the current second slice data amount may be directly used as the target second slice data amount. By dynamically decreasing the second slice data amount, the wait count may be reduced, and further the video entire uploading efficiency may be improved.

S350, in response to determining that the data amount of the current video data is greater than or equal to the target second slice data amount, using the current video data as the current video slice to be uploaded currently, and performing step S370.

Specifically, where the data amount of the current video data is greater than or equal to the target second slice data amount, the currently obtained currently video data may be directly used as the current video slice to be uploaded, without the need of waiting for the available video data amount synthesized by the encoder to accumulate to the target first slice data amount, thus further reducing the video entire uploading time consumption.

It is to be noted where the data amount of the current video data is less than the target second slice data amount, it is necessary to wait for the available video data amount synthesized by the encoder to reach the target second slice data amount before being uploaded.

S360, slicing the current video data based on the target first slice data amount to obtain a current video slice to be uploaded currently, and performing step S370.

S370, uploading the current video slice.

According to the technical solution of the embodiments of the present disclosure, in response determining to that a data amount of the current video data is less than the target first slice data amount, a target second slice data amount is obtained; and in response to determining that the data amount of the current video data is greater than or equal to the target second slice data amount, the current video data is directly used as the current video slice to be uploaded currently, without the need of waiting for the available vide data amount synthesized by the encoder to accumulate to the target first slice data amount, thus further reducing the video entire uploading time consumption.

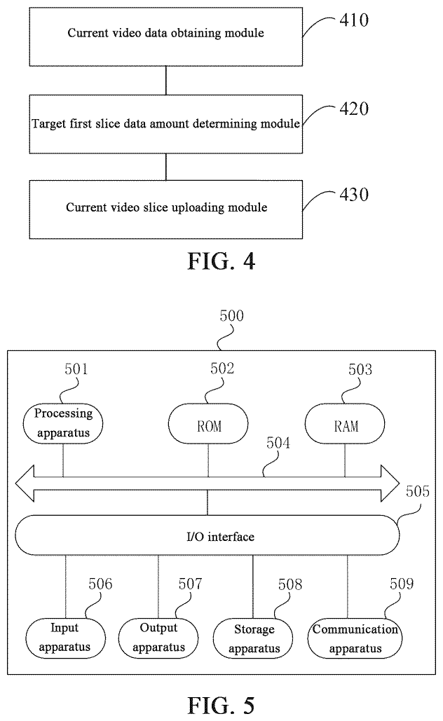

FIG. 4 is a structural schematic diagram of a video uploading apparatus according to an embodiment of the present disclosure. As shown in FIG. 4, the apparatus specifically comprises: a current video data obtaining module 410, a target first slice data amount determining module 420 and a current video slice uploading module 430.

The current video data obtaining module 410 is configured to obtain current video data to be uploaded; the target first slice data amount determining module 420 is configured to determine a target first slice data amount matching a current upload network based on historical upload network information; and the current video slice uploading module 430 is configured to slice the current video data based on the target first slice data amount to obtain a current video slice to be uploaded currently, and upload the current video slice.

According to the technical solution of the embodiments, a target first slice data amount matching a current upload network is determined based on historical upload network information; the current video data is sliced based on the target first slice data amount to obtain a current video slice to be uploaded currently, and the current video slice is uploaded. In this way, video data is uploaded in the form of a slice, and each slice may be independently uploaded and checked, so that only slices which fail to be transmitted may be re-transmitted and the entire video data avoids retransmission. Moreover, during the video uploading process, the slice data amount uploaded each time may be dynamically adjusted, so that the video slice data amount matches an upload network each time and further the upload success rate of the video slice may be increased.

Based on the foregoing technical solution, the target first slice data amount determining module 420 comprises:
a current upload network level determining unit configured to perform a current upload network prediction based on historical upload network information, to determine a current upload network level;
an update condition detecting unit configured to detect, based on the current upload network level and a historical upload network level, whether a first slice data amount update condition is currently met;

A first determining unit configured to update a current first slice data amount in response to determining that the first slice data amount update condition is currently met, and determine the updated current first slice data amount as a target first slice data amount matching a current upload network; and
a second determining unit configured to, in response to determining that the first slice data amount update condition is not met currently, determine a current first slice data amount as a target first slice data amount matching a current upload network.

Based on the foregoing respective technical solutions, the current upload network level determining unit is specifically configured to:
predict a current upload network speed based on at least one of a historical upload network speed, a historical upload failure rate and a historical retransmission count; and
determine a current upload network level based on a correspondence relationship between the current upload network speed, an upload network speed interval and an upload network level.

Based on the foregoing respective technical solutions, the update condition detecting unit is specifically configured to:
determine that a first slice data amount increase condition is currently met in response to determining, based on a current upload network level and a historical upload network level, that a count that two adjacent upload network levels have continuously increased is greater than a preset count; and
determine a first slice data amount decrease condition is currently met in response to determining, based on a current upload level and a historical upload network level, that a count that two adjacent upload network levels have continuously decreased is greater than a preset count.

Based on the foregoing respective technical solutions, the first determining unit comprises:
a first slice data amount increasing sub-unit configured to, in response to determining that a first slice data amount increase condition is currently met, increase a current first slice data amount, and determine the increased current first slice data amount as a target first slice data amount matching a current upload network; and
a first slice data amount decreasing sub-unit configured to, in response to determining that a first slice data amount decrease condition is currently met, decrease a current first slice data amount, and determine the decreased current first slice data amount as a target first slice data amount matching a current upload network.

Based on the foregoing respective technical solutions, the first slice data amount increasing sub-unit is specifically configured to:
use a next first slice data amount which is adjacent to a current first slice data amount as an increased current first slice data amount based on an order of a first slice data amount sequence; or use a first slice data amount corresponding to a current upload network level as an increased current first slice data amount based on a correspondence relationship between an upload network level and a first slice data amount.

Based on the foregoing respective technical solutions, the target first slice data amount determining unit 420 is specifically configured to:
input historical upload network information to a pretrained neural network model for prediction of a first slice data amount; and obtain a target first slice data amount matching a current upload network based on an output of the neural network model.

Based on the foregoing respective technical solutions, the current video data obtaining module 410 is specifically configured to:
obtain available video data currently synthesized by an encoder, and use the available video data as current video data to be uploaded.

Based on the foregoing respective technical solutions, the current video slice uploading module 430 comprises:
a target second slice data amount obtaining unit configured to, in response determining to that a data amount of the current video data is less than the target first slice data amount, obtain a target second slice data amount, the target second slice data amount being less than the target first slice data amount; and
a current video slice determining unit configured to, in response to determining that the data amount of the current video data is greater than or equal to the target second slice data amount, use the current video data as the current video slice to be uploaded currently.

Based on the foregoing respective technical solutions, the target second slice data amount obtaining unit is specifically configured to:
detect whether a second slice data amount decrease condition is currently met, based on a data synthesis speed and/or a historical upload wait count;
in response to determining that the second slice data amount decrease condition is currently met, decrease a current second slice data amount, and use the decreased current second slice data amount as the target second slice data amount; and
in response to determining that the second slice data amount decrease condition is not met currently, use a current second slice data amount as the target second slice data amount.

The video uploading apparatus provided by the embodiments of the present disclosure can perform the video uploading method provided by any embodiment of the present disclosure, which includes corresponding functional modules for performing the method and has the advantageous effects.

It is to be noted that respective units and modules comprised in the foregoing apparatus are merely divided according to functional logic, but are not limited to such division, so long as corresponding functions can be performed. In addition, specific names of the respective functional units are merely for mutual differentiation and are not intended to limit the protection scope of the embodiments of the present disclosure.

FIG. 5 is a structural schematic diagram of an electronic device provided by an embodiment of the present disclosure. With reference to FIG. 5 below, this figure shows a structural schematic diagram of an electronic device 500 (e.g., a terminal device or server in FIG. 5) which is applicable to implement the embodiments of the present disclosure. The terminal device in the embodiment of the present disclosure may include, but is not limited to, a mobile terminal such as a mobile phone, a notebook computer, a digital broadcast receiver, a PDA (personal digital assistant), a PAD (portable Android device), a PMP (portable multimedia player), an on-board terminal (e.g., an on-board navigation terminal), a wearable terminal device and the like, and a fixed terminal such as digital TV, a desktop computer and the like. The electronic device shown in FIG. 5 is merely an example and should not be construed as bringing any restriction on the functionality and usage scope of the embodiments of the present disclosure.

As shown in FIG. 5, the electronic device 500 may comprise a processing apparatus (e.g., a central processor, a graphics processor) 501 which is capable of performing various appropriate actions and processes as described in the embodiments of the present disclosure in accordance with programs stored in a read only memory (ROM) 502 or programs loaded from a storage apparatus 508 to a random access memory (RAM) 703. In the RAM 503, there are also stored various programs and data required by the electronic device 500 when operating. The processing apparatus 501, the ROM 502 and the RAM 503 are connected to one another via a bus 504. An input/output (I/O) interface 505 is also connected to the bus 504.

Typically, the following units may be connected to the I/O interface 505: an input apparatus 506 including, for example, a touchscreen, a touch pad, a keyboard, a mouse, a camera, a microphone, an accelerometer, a gyroscope and the like; an output apparatus 507 including, for example, a Liquid Crystal Display (LCD), a loudspeaker, a vibrator and the like; a storage apparatus 508 including, for example, a tape, a hard drive and the like; and a communication apparatus 509. The communication apparatus 509 can allow wireless or wired communication of the electronic device 500 with other devices to exchange data. Although FIG. 5 shows the terminal device 500 with various apparatuses, it should be understood that it is not required to implement or have all of the illustrated apparatuses. Alternatively, more or less apparatuses may be implemented or exist.

In particular, according to embodiments of the present disclosure, the processes described above with reference to the flowcharts may be implemented as computer software programs. For example, embodiments of the present disclosure include a computer program product comprising a computer program carried on a non-transitory computer readable medium, the computer program containing program code for performing the methods as in the flowcharts. In those embodiments, the computer program may be downloaded and installed from a network via the communication apparatus 509, or may be installed from the storage apparatus 508, or may be installed from the ROM 502. The computer program, when executed by the processing apparatus 501, performs the above-described functions defined in the method according to the embodiments of the present disclosure.

Names of messages or information interacted between a plurality of apparatuses in the implementations of the present disclosure are merely for illustration purposes, rather than limiting the scope of these messages or information.

The electronic device provided in this embodiment of the present disclosure and the video uploading method provided in the foregoing embodiments belong to the same inventive concept, technical details which are not described in this embodiment may refer to the foregoing embodiments, and this embodiment has the same advantageous effect as the foregoing embodiments.

An embodiment of the present disclosure provides a computer storage medium, storing a computer program thereon, wherein the program, when executed by a processor, implements a video uploading method provided in the foregoing embodiments.

It is to be noted that the computer readable medium according to the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, an RAM, an ROM, an erasable programmable read-only memory (EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that can contain, or store, a program for use by or in connection with an instruction execution system, apparatus, or device. In contrast, in the present disclosure, a computer readable signal medium may include a propagated data signal with computer readable program code embodied therein, either in baseband or as part of a carrier wave. Such propagated data signal may take many forms, including, but not limited to, an electro-magnetic signal, an optical signal, or any suitable combination thereof. A computer readable signal medium may also be any computer readable medium that is not a computer readable storage medium and that can communicate, propagate, or transmit a program for use by or in connection with an instruction execution system, apparatus, or device. Program code embodied on a computer readable medium may be transmitted using any appropriate medium, including but not limited to: electrical wires, optical cables, RF (radio frequency), etc., or any suitable combination of the foregoing.

In some implementations, the client and the server may perform communication by using any known network protocol such as Hyper Text Transfer Protocol (HTTP) or any network protocol to be developed, and may connect with digital data in any form or carried in any medium (for example, a communication network). The communication network includes a local area network (LAN), a wide area network (WAN), an international network (for example, the internet), a peer-to-peer network (e.g. ad hoc peer-to-peer network), and any known network or network to be developed.

The computer readable medium may be the one included in the electronic device, or may be provided separately, rather than assembled in the electronic device.

The computer readable medium carries one or more programs which, when executed by the electronic device, cause the electronic device to: obtain current video data to be uploaded; determine a target first slice data amount matching a current upload network based on historical upload network information; and slice the current video data based on the target first slice data amount to obtain a current video slice to be uploaded currently, and upload the current video slice Computer program codes for carrying out operations of the present disclosure may be written in one or more programming languages, including without limitation to, an object oriented programming language such as Java, Smalltalk, C++ or the like, and conventional procedural programming languages, such as the “C” programming language or similar programming languages. The program codes may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units described in the embodiments of the present disclosure may be implemented as software or hardware, wherein the name of a unit does not form any limitation to the unit per se in some case.

The functions described above may be executed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In the context of the present disclosure, the machine readable medium may be a tangible medium, which may include or store a program used by an instruction executing system, apparatus or device or used in conjunction with the foregoing. The machine readable medium may be a machine readable signal medium or a machine readable storage medium. The machine readable medium may include, but is not limited to, an electronic, magnetic, optical, electromagnetic, infrared, semiconductor system, means or device, or any suitable combination of the foregoing. More specific examples of the machine-readable storage medium include the following: an electric connection with one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

According to one or more embodiments of the present disclosure, Example One provides a video uploading method, the method comprising:
obtaining current video data to be uploaded;
determining a target first slice data amount matching a current upload network based on historical upload network information; and
slicing the current video data based on the target first slice data amount to obtain a current video slice to be uploaded currently, and uploading the current video slice.

According to one or more embodiments of the present disclosure, Example Two provides a video uploading method, wherein,
optionally, determining the target first slice data amount matching the current upload network based on the historical upload network information comprises comprises:
performing a current upload network prediction based on historical upload network information, to determine a current upload network level;
detecting, based on the current upload network level and a historical upload network level, whether a first slice data amount update condition is currently met;
updating a current first slice data amount in response to determining that the first slice data amount update condition is currently met, and determining the updated current first slice data amount as a target first slice data amount matching a current upload network; and
in response to determining that the first slice data amount update condition is not met currently, determining a current first slice data amount as a target first slice data amount matching a current upload network.

According to one or more embodiments of the present disclosure, Example Three provides a video uploading method, wherein
optionally, performing the current upload network prediction based on the historical upload network information to determine the current upload network level comprises:
predicting a current upload network speed based on at least one of a historical upload network speed, a historical upload failure rate and a historical retransmission count; and
determining a current upload network level based on a correspondence relationship between the current upload network speed, an upload network speed interval and an upload network level.

According to one or more embodiments of the present disclosure, Example Four provides a video uploading method, wherein

Optionally, detecting, based on the current upload network level and the historical upload network level, whether the first slice data amount update condition is currently met comprises:
determining that a first slice data amount increase condition is currently met in response to determining, based on a current upload network level and a historical upload network level, that a count that two adjacent upload network levels have continuously increased is greater than a preset count; and
determining a first slice data amount decrease condition is currently met in response to determining, based on a current upload level and a historical upload network level, that a count that two adjacent upload network levels have continuously decreased is greater than a preset count.

According to one or more embodiments of the present disclosure, Example Five provides a video uploading method, wherein
optionally, updating a current first slice data amount in response to determining that the first slice data amount update condition is currently met, and determining the updated current first slice data amount as a target first slice data amount matching a current upload network comprises:
in response to determining that a first slice data amount increase condition is currently met, increasing a current first slice data amount, and determining the increased current first slice data amount as a target first slice data amount matching a current upload network; and
in response to determining that a first slice data amount decrease condition is currently met, decreasing a current first slice data amount, and determining the decreased current first slice data amount as a target first slice data amount matching a current upload network.

According to one or more embodiments of the present disclosure, Example Six provides a video uploading method, wherein
optionally, increasing the current first slice data amount comprises:
using a next first slice data amount which is adjacent to a current first slice data amount as an increased current first slice data amount based on an order of a first slice data amount sequence; or
using a first slice data amount corresponding to a current upload network level as an increased current first slice data amount based on a correspondence relationship between an upload network level and a first slice data amount.

According to one or more embodiments of the present disclosure, Example Seven provides a video uploading method, wherein
optionally, determining the target first slice data amount matching the current upload network based on the historical upload network information comprises:
inputting historical upload network information to a pretrained neural network model for prediction of a first slice data amount; and
obtaining a target first slice data amount matching a current upload network based on an output of the neural network model.

According to one or more embodiments of the present disclosure, Example Eight provides a video uploading method, wherein
optionally, obtaining the current video data to be uploaded comprises:
obtaining available video data currently synthesized by an encoder, and using the available video data as current video data to be uploaded.

According to one or more embodiments of the present disclosure, Example Nine provides a video uploading method, wherein
optionally, slicing the current video data based on the target first slice data amount to obtain the current video slice to be uploaded currently comprises:
in response determining to that a data amount of the current video data is less than the target first slice data amount, obtaining a target second slice data amount, the target second slice data amount being less than the target first slice data amount; and
in response to determining that the data amount of the current video data is greater than or equal to the target second slice data amount, using the current video data as the current video slice to be uploaded currently.

According to one or more embodiments of the present disclosure, Example Ten provides a video uploading method, wherein
optionally, obtaining the target second slice data amount comprises:
detecting whether a second slice data amount decrease condition is currently met, based on a data synthesis speed and/or a historical upload wait count;
in response to determining that the second slice data amount decrease condition is currently met, decreasing a current second slice data amount, and using the decreased current second slice data amount as the target second slice data amount; and
in response to determining that the second slice data amount decrease condition is not met currently, using a current second slice data amount as the target second slice data amount.

According to one or more embodiments of the present disclosure, Example Eleven provides a video uploading apparatus, comprising:
a current video data obtaining module configured to obtain current video data to be uploaded;
a target first slice data amount determining module configured to determine a target first slice data amount matching a current upload network based on historical upload network information; and
a current video slice uploading module configured to slice the current video data based on the target first slice data amount to obtain a current video slice to be uploaded currently, and upload the current video slice.

The foregoing description merely illustrates the preferable embodiments of the present disclosure and used technical principles. Those skilled in the art should understand that the scope of the present disclosure is not limited to technical solutions formed by specific combinations of the foregoing technical features and also cover other technical solution formed by any combinations of the foregoing or equivalent features without departing from the concept of the present disclosure, such as a technical solution formed by replacing the foregoing features with the technical features disclosed in the present disclosure (but not limited to) with similar functions.

In addition, although various operations are depicted in a particular order, this should not be construed as requiring that these operations be performed in the particular order shown or in a sequential order. In a given environment, multitasking and parallel processing may be advantageous. Likewise, although the above discussion contains several specific implementation details, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments separately or in any suitable subcombination.

Although the subject matter has been described in language specific to structural features and/or method logical acts, it is to be understood that the subject matter defined in the appended claims is not necessarily limited to the specific features or acts described above. On the contrary, the specific features and acts described above are merely example forms of implementing the claims.

1. A video uploading method, comprising:
obtaining current video data to be uploaded;
determining a target first slice data amount matching a current upload network based on historical upload network information; and
slicing the current video data based on the target first slice data amount to obtain a current video slice to be uploaded currently, and uploading the current video slice.

2. The video uploading method of claim 1, wherein determining the target first slice data amount matching the current upload network based on the historical upload network information comprises:
performing a current upload network prediction based on the historical upload network information to determine a current upload network level;
detecting, based on the current upload network level and a historical upload network level, whether a first slice data amount update condition is currently met;
updating a current first slice data amount in response to determining that the first slice data amount update condition is currently met, and determining the updated current first slice data amount as the target first slice data amount matching the current upload network; and
in response to determining that the first slice data amount update condition is not met currently, determining the current first slice data amount as the target first slice data amount matching the current upload network.

3. The video uploading method of claim 2, wherein performing the current upload network prediction based on the historical upload network information to determine the current upload network level comprises:
predicting a current upload network speed based on at least one of a historical upload network speed, a historical upload failure rate and a historical retransmission count; and
determining the current upload network level based on a correspondence relationship between the current upload network speed, an upload network speed interval and an upload network level.

4. The video uploading of claim 2, wherein detecting, based on the current upload network level and the historical upload network level, whether the first slice data amount update condition is currently met comprises:
determining that a first slice data amount increase condition is currently met in response to determining, based on the current upload network level and the historical upload network level, that a count that two adjacent upload network levels have continuously increased is greater than a preset count; and
determining a first slice data amount decrease condition is currently met in response to determining, based on the current upload level and the historical upload network level, that a count that two adjacent upload network levels have continuously decreased is greater than a preset count.

5. The video uploading method of claim 2, wherein updating the current first slice data amount in response to determining that the first slice data amount update condition is currently met, and determining the updated current first slice data amount as the target first slice data amount matching the current upload network comprises:
in response to determining that a first slice data amount increase condition is currently met, increasing the current first slice data amount, and determining the increased current first slice data amount as the target first slice data amount matching the current upload network; and
in response to determining that a first slice data amount decrease condition is currently met, decreasing the current first slice data amount, and determining the decreased current first slice data amount as the target first slice data amount matching the current upload network.

6. The video uploading method of claim 5, wherein increasing the current first slice data amount comprises at least one of:
using a next first slice data amount which is adjacent to the current first slice data amount as the increased current first slice data amount based on an order of a first slice data amount sequence; or
using a first slice data amount corresponding to the current upload network level as the increased current first slice data amount based on a correspondence relationship between an upload network level and the first slice data amount.

7. The video uploading method of claim 1, wherein determining the target first slice data amount matching the current upload network based on the historical upload network information comprises:
inputting the historical upload network information to a pretrained neural network model for prediction of a first slice data amount; and
obtaining the target first slice data amount matching the current upload network based on an output of the neural network model.

8. The video uploading method of claim 1, wherein obtaining the current video data to be uploaded comprises:
obtaining available video data currently synthesized by an encoder, and using the available video data as the current video data to be uploaded.

9. The video uploading method of claim 8, wherein slicing the current video data based on the target first slice data amount to obtain the current video slice to be uploaded currently comprises:
in response determining to that a data amount of the current video data is less than the target first slice data amount, obtaining a target second slice data amount, wherein the target second slice data amount is less than the target first slice data amount; and
in response to determining that the data amount of the current video data is greater than or equal to the target second slice data amount, using the current video data as the current video slice to be uploaded currently.

10. The video uploading method of claim 9, wherein obtaining the target second slice data amount comprises:
detecting whether a second slice data amount decrease condition is currently met based on at least one of a data synthesis speed or a historical upload wait count;
in response to determining that the second slice data amount decrease condition is currently met, decreasing a current second slice data amount, and using the decreased current second slice data amount as the target second slice data amount; and
in response to determining that the second slice data amount decrease condition is not met currently, using the current second slice data amount as the target second slice data amount.

11. (canceled)

12. An electronic device, comprising:
one or more processors; and
a storage unit for storing one or more programs; wherein:
the one or more programs, when executed by the one or more processors, cause the one or more processors to:
obtain current video data to be uploaded;
determine a target first slice data amount matching a current upload network based on historical upload network information; and
slice the current video data based on the target first slice data amount to obtain a current video slice to be uploaded currently, and upload the current video slice.

13. A non-transitory computer storage medium comprising computer executable instructions, wherein the computer executable instructions, when executed by a processor, cause the-processor to:
obtain current video data to be uploaded:
determine a target first slice data amount matching a current upload network based on historical upload network information; and
slice the current video data based on the target first slice data amount to obtain a current video slice to be uploaded currently, and upload the current video slice.

14. The electronic device of claim 12, wherein the instructions to determine the target first slice data amount matching the current upload network based on the historical upload network information comprise instructions to:
perform a current upload network prediction based on the historical upload network information to determine a current upload network level;
detect, based on the current upload network level and a historical upload network level, whether a first slice data amount update condition is currently met;
update a current first slice data amount in response to determining that the first slice data amount update condition is currently met, and determine the updated current first slice data amount as the target first slice data amount matching the current upload network; and
in response to determining that the first slice data amount update condition is not met currently, determine the current first slice data amount as the target first slice data amount matching the current upload network.

15. The electronic device of claim 14, wherein the instructions to perform the current upload network prediction based on the historical upload network information to determine the current upload network level comprise instructions to:
predict a current upload network speed based on at least one of a historical upload network speed, a historical upload failure rate and a historical retransmission count; and
determine the current upload network level based on a correspondence relationship between the current upload network speed, an upload network speed interval and an upload network level.

16. The electronic device of claim 14, wherein the instructions to detect, based on the current upload network level and the historical upload network level, whether the first slice data amount update condition is currently met comprise instructions to:
determine that a first slice data amount increase condition is currently met in response to determining, based on the current upload network level and the historical upload network level, that a count that two adjacent upload network levels have continuously increased is greater than a preset count; and
determine a first slice data amount decrease condition is currently met in response to determining, based on the current upload level and the historical upload network level, that a count that two adjacent upload network levels have continuously decreased is greater than a preset count.

17. The electronic device of claim 16, wherein the instructions to update the current first slice data amount in response to determining that the first slice data amount update condition is currently met, and determine the updated current first slice data amount as the target first slice data amount matching the current upload network comprise instructions to:
in response to determining that a first slice data amount increase condition is currently met, increase the current first slice data amount, and determine the increased current first slice data amount as the target first slice data amount matching the current upload network; and
in response to determining that a first slice data amount decrease condition is currently met, decrease the current first slice data amount, and determine the decreased current first slice data amount as the target first slice data amount matching the current upload network.

18. The electronic device of claim 17, wherein the instructions to increase the current first slice data amount comprises instructions to perform at least one of:
use a next first slice data amount which is adjacent to the current first slice data amount as the increased current first slice data amount based on an order of a first slice data amount sequence; or
use a first slice data amount corresponding to the current upload network level as the increased current first slice data amount based on a correspondence relationship between an upload network level and the first slice data amount.

19. The electronic device of claim 12, wherein the instructions to determine the target first slice data amount matching the current upload network based on the historical upload network information comprise instructions to:
input the historical upload network information to a pretrained neural network model for prediction of a first slice data amount; and
obtain the target first slice data amount matching the current upload network based on an output of the neural network model.

20. The electronic device of claim 12, wherein the instructions to obtain the current video data to be uploaded comprise instructions to:
obtain available video data currently synthesized by an encoder, and using the available video data as the current video data to be uploaded.

21. The electronic device of claim 20, wherein the instructions to slice the current video data based on the target first slice data amount to obtain the current video slice to be uploaded currently comprise instructions to:
in response determining to that a data amount of the current video data is less than the target first slice data amount, obtain a target second slice data amount, wherein the target second slice data amount is less than the target first slice data amount; and
in response to determining that the data amount of the current video data is greater than or equal to the target second slice data amount, use the current video data as the current video slice to be uploaded currently.
